(19) United States
(12) Patent Application Publication
(10) Pub. No.: US 2009/0298011 A1
(43) Pub. Date: Dec. 3, 2009

(54) Suction Machine

(75) Inventors: Michael Thoms, Bietigheim-Bissingen (DE); Juergen Schnepf, Heilbronn (DE)

Correspondence Address: FACTOR & LAKE, LTD, 1327 W. WASHINGTON BLVD., SUITE 5G/H, CHICAGO, IL, 60607, US

(73) Assignee: DUERR DENTAL GMBH & CO KG, Bietigeim-Bissingen (DE)

(21) Appl. No.: 12/294,291

(22) PCT Filed: Mar. 3, 2007
(86) PCT No.: PCT/EP07/01835

§ 371 Date: Apr. 13, 2009

(30) Foreign Application Priority Data
Mar. 28, 2006 (DE) 10 2006 014 682.4

(51) Int. Cl. A61C 17/06

(52) U.S. Cl. 433/92

(57) ABSTRACT

A suction machine intended for a dental or surgical suction installation is specified that includes a separating unit, which contains a rotor and is used to separate liquid and if appropriate solid constituents from a suctioned mixture of air, liquid and if appropriate solids, and a suction fan, which is connected to an air outlet of the separating unit and has a housing and an impeller. The suction fan is designed as a radial fan whose impeller is driven by an electrically commuted electric motor, which drives the rotor of the separating unit via a gearing.

The present invention relates to a suction machine with a separating unit for separating liquid and—where appropriate—solid constituents out of an aspirated air/liquid mixture, and with a suction fan which is connected to an air outlet of the separating unit.

Such a suction machine is known from EP 0 400 431 A1. The suction machine described therein consists of a separating unit which is connected to a suction fan. The separating unit exhibits a cyclone separator and a centrifuge, which are arranged coaxially.

Suction machines are employed in dental or surgical suction-extraction systems. The air/liquid mixture aspirated from the mouth of the patient or from the operative field by, respectively, the dentist or surgeon firstly has to be separated in the separating unit into its liquid and—where appropriate—solid constituents, on the one hand, and the air components, on the other hand.

By way of suction fan with which the air components are withdrawn from the outlet of the separating unit and a partial vacuum is generated for the aspiration, currently quiet-running side-channel blowers come into operation in many cases.

Smaller suction machines can be directly integrated within the treatment unit, whereas larger suction machines, installed centrally, can be provided for the simultaneous maintenance of several treatment sites.

The side-channel blowers that are employed nowadays have a relatively poor efficiency of only about 0.25-0.3 per stage at the best point. In addition, their power demand rises with the desired partial vacuum. In the case of a suction machine for four dental treatment sites, for example, an electric motor with a connected load of approximately 1.5 kW has to be provided.

Suction fans for dental or surgical suction machines are ordinarily driven nowadays by single-phase or three-phase motors, which attain a maximum efficiency of 60-70%.

A further consideration is that precisely in the case of multiple-site instruments a demand-dependent control of the suction power would be desirable, in order not to have to operate the suction fan constantly within the full-load range. However, this requires technically elaborate and expensive control electronics.

The object of the invention is therefore to specify a suction machine of the initially stated type that exhibits a better efficiency and that, in particular, is suitable for the maintenance of several treatment sites.

The object is achieved by means of a suction machine having the features of Claim 1.

Advantageous configurations can be gathered from the dependent claims.

In accordance with the invention, in the case of a suction machine of the initially stated type the suction fan is realised as a radial-flow blower, the impeller of which is driven by an electrically commutated electric motor (EC motor).

In contrast to a side-channel blower, a radial-flow blower exhibits a distinctly higher efficiency of approximately 0.6-0.7 per stage at the best point. In addition, the power demand of a radial-flow blower is smaller within the partial-load range, because radial-flow blowers require more power, the higher the volumetric flow becomes. On the other hand, in the case of high partial vacuum but low volumetric flow—as is typically the case in dental or surgical suction-extraction systems—the power demand is relatively low. In addition, in operation the radial-flow blower is less sensitive with respect to aspirated liquid residues, foam or dust. By virtue of the lower mass of the impeller of a radial-flow blower in comparison with a side-channel blower, in addition a faster start-up is ensured.

In comparison with conventional single-phase or three-phase motors, the electrically commutated motor also exhibits a higher efficiency of approximately 80-85%. As a result, current consumption and waste heat are lower.

Since an electrically commutated motor operates in brushless manner, it is practically wear-free and has a longer service life.

In addition, the electronics required for the operation of an electrically commutated motor permit a speed control, with the aid of which a demand-dependent suction-power regulation can be realised without great effort.

In accordance with the invention, the separating unit and the radial-flow blower are mechanically coupled with one another, preferentially in such a manner that the separating unit runs more slowly than the radial-flow blower. Accordingly, both the radial-flow blower and the separating unit can be operated with the EC motor, and differing speed requirements of the two sub-units can be taken into account.

The coupling can expediently be realised by a gearwheel transmission. But alternatively a coupling via a V-belt transmission, a toothed-belt transmission or via a friction-gear transmission also enters into consideration.

The use of an obliquely toothed gearwheel transmission proves to be particularly advantageous.

If one gearwheel is constructed from plastic and a second gearwheel, engaging therein, is constructed from metal, a particularly quiet transmission coupling can be realised and the transmission also gets by without lubrication.

If the control electronics of the EC motor are accommodated in an motor chamber, resulting in a particularly compact design, a fan is expediently provided for cooling the motor electronics. The fan may advantageously be arranged on the drive shaft of the separating unit.

The air outlet of the separating unit can be connected in simple manner to a suction port of the radial-flow blower via an external pipeline.

The separating unit preferentially includes a cyclone-separator stage and a pump stage or a centrifuge stage, which are arranged coaxially. As a result, a good separation of the air/liquid mixture extracted by suction is achieved.

If the electric motor is realised as an external-rotor motor, the suction machine can be constructed in particularly compact manner. In addition, an external-rotor motor enables the transmission of high torques, and can be operated at high speeds.

Further advantages can be gathered from the description of the following exemplary embodiment of the invention, which will be elucidated in more detail below on the basis of the drawings. Shown are:

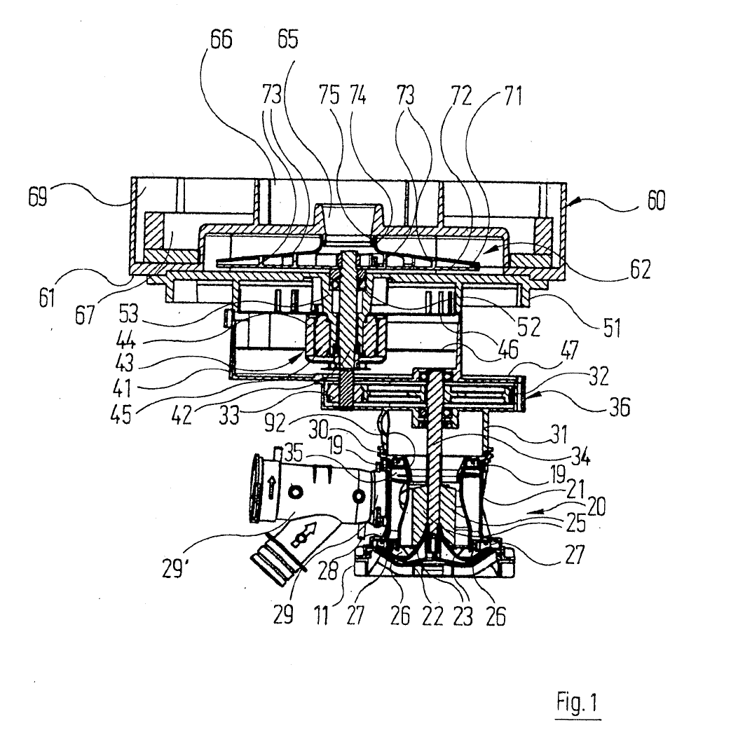

FIG. 1 a sectional drawing of a suction machine,

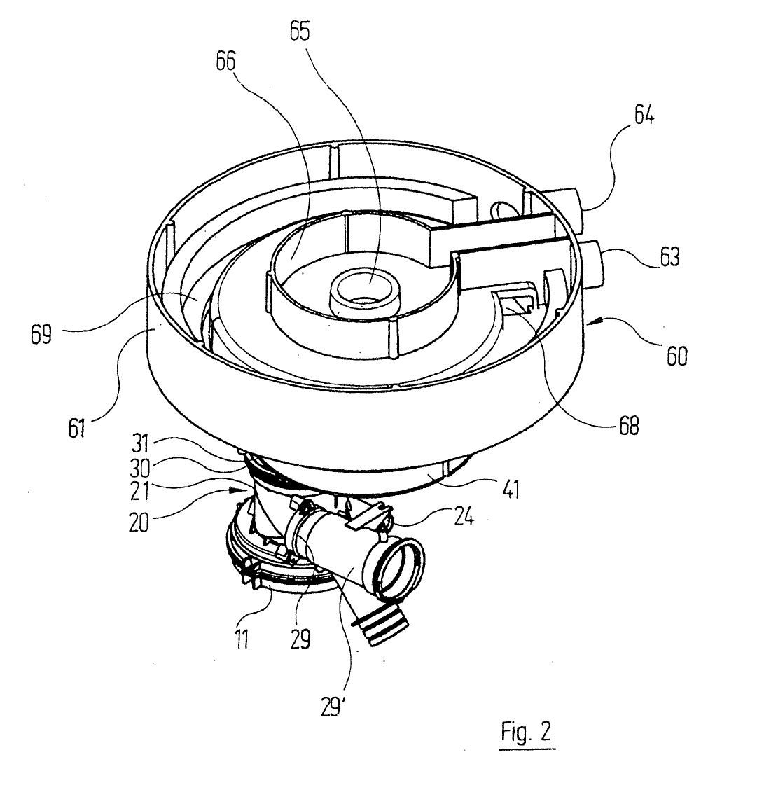

FIG. 2 an isometric representation of the suction machine from FIG. 1 in a view rotated by about 120°,

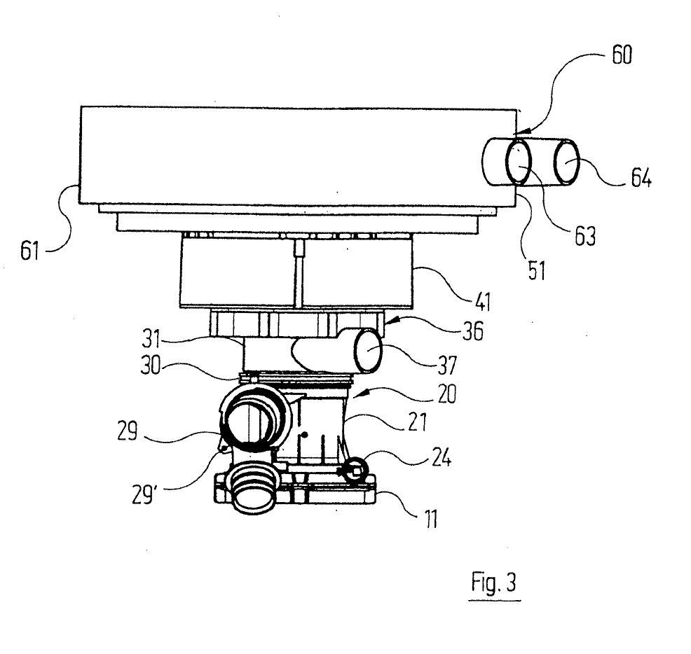

FIG. 3 a side view of the suction machine, rotated by 90° in comparison with FIG. 1,

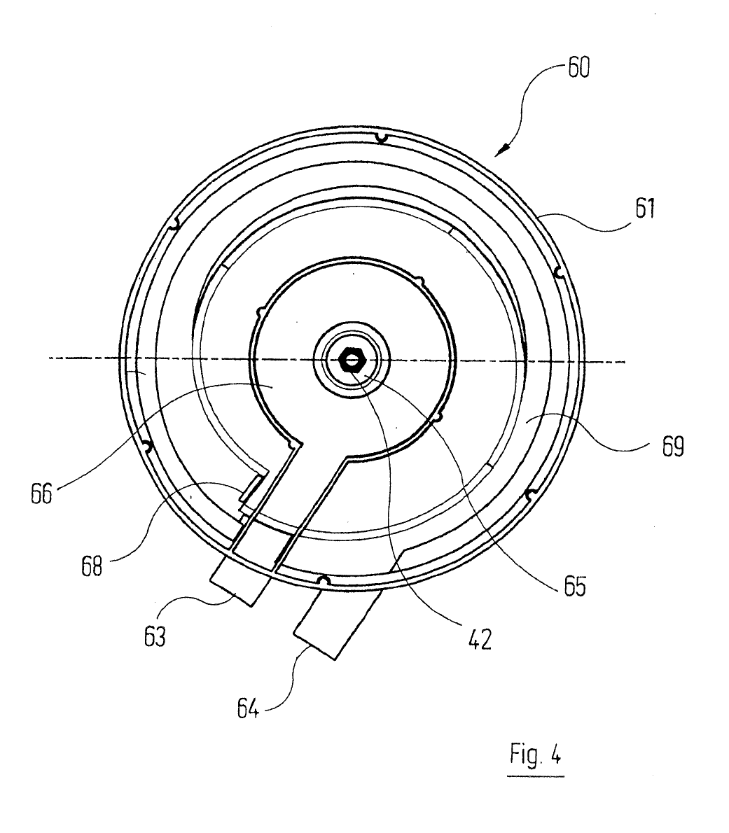

FIG. 4 a top view on the suction machine from FIG. 1 and

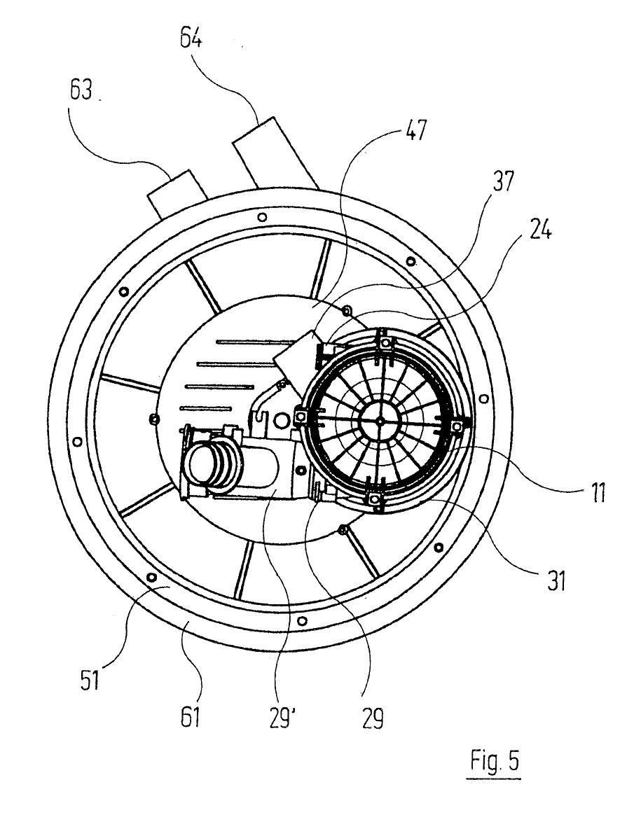

FIG. 5 a view of the suction machine from FIG. 1 from below.

The suction machine shown in FIGS. 1 to 5 possesses a lower casing cover 11, onto which a cup-shaped casing segment 21 of a separating unit 20 has been screwed from above.

At the top, the casing segment 21 is sealed by an annular intermediate flange 30 which in the centre exhibits a downward-hanging outlet port 92 for air that has been freed of liquid components.

An inlet port 29 of the separating unit 20 leads tangentially and laterally into the casing 21 (see FIG. 2) and discharges in a spiral duct 35 which issues into the interior of the casing 21. Onto the inlet port 29 a y-shaped branching piece 29′ is screwed, to which, for example, two dental suction extractors can be separately connected.

From above, the intermediate flange 30 is screw-coupled with a two-chamber casing segment 31, the lower chamber of which serves as air-outlet chamber of the separating unit 20, and which laterally bears an outlet port 37 (see FIG. 3). The upper chamber of the casing 31 serves for receiving a gearwheel transmission 36.

Upwardly, the casing segment 31 is sealed by another casing segment 41 which serves as motor chamber, which is mounted in laterally offset manner, and the underside of which takes the form of a cover 47 for the upper chamber of the casing segment 31. Upwardly, the casing segment 41 is sealed by a cover 51.

The cover 51 projects radially beyond the casing segment 41 and simultaneously forms the base for a spiral casing 61 of a radial-flow blower 60. The spiral casing 61 together with the cover 51 forms a working chamber 67 for an impeller 62.

In the centre of the spiral casing 61 there is located a round air conduit 65 which leads into an inlet chamber 66 which communicates with a tubular suction port 63. The working chamber 67, which otherwise exhibits a round cross-section, exhibits a tangential air-outlet opening 68 (see FIG. 2) which extends into a spiral duct 69 which leads around the working chamber 67 to a tubular air outlet 64. In FIG. 4 the course of the spiral duct 69 can be discerned in top view. The spiral casing 61 is sealed at the top by a round upper sheet-metal cover, which is not shown.

Under operating conditions, the air outlet 37 of the separating unit 20 is connected to the suction port 63 of the radial-flow blower 60 via an external pipeline, not shown here, which may be a hose or tube.

In the casing segment 21 of the separating unit 20 there are arranged on a common drive shaft 34, one above the other, a pump impeller 23 and a rotor 22, which widens downwards in a bell shape, of a cyclone separator.

In the upper region of the rotor 22 a web designed in the form of a ring helix and surrounding the rotor 22 is provided, which together with an opposite web on the inner wall of the casing 21 forms the spiral duct 35, via which the aspirated air/liquid mixture is conveyed into the separating unit 20.

On the upper edge the rotor 22 exhibits a relatively large number of radial pump blades 19, distributed in the circumferential direction, which in the centre have a narrow rectangular recess and together with a correspondingly shaped rib of the intermediate flange 30 form a dynamic packing with recirculating action, so that there is no direct flow connection from the interior space of the casing 21 to the central conduit opening of the intermediate flange 30.

In its interior space the rotor 22 exhibits several (e.g. six) blades 25 extending in planar manner in the vertical and radial directions between the drive shaft 34 and the inner wall of the rotor 22, which subdivides the interior space of the rotor 22 into several sectors which are laterally sealed in relation to one another.

Below the rotor 22 there is located an annular-gully-shaped pump impeller 23, the outer wall of which extends obliquely upwards over the bottom edge of the rotor 22. Several radial webs 26 are arranged in the interior of the pump impeller 23. On the outer edge of the pump impeller 23 there are located, distributed over the periphery, a relatively large number of pump blades 27 which in the centre each have a narrow rectangular recess.

Above the ring of pump blades 27 the diameter of the casing segment 21 diminishes in a shoulder 28 which in this way together with the bottom cover 11 delimit a liquid-outlet chamber.

From the shoulder 28 a blocking web 81 stands down in the manner of a ring and projects into the rectangular recesses of the pump blades 27. In this way, the pump blades 27 form a dynamic packing together with the shoulder 28 and with the blocking web 81 projecting from said shoulder into the recess of the pump blades 27.

The pump blades 27 extend beyond the shoulder 28 inwards into the pump impeller 23 and in this way convey liquid, which drips from the rotor 22 into the pump impeller 23 and which is pushed outwards by the centrifugal force, to a liquid-outlet port 24 (see FIG. 3) which emanates tangentially from a lower peripheral wall of the casing segment 21, which is situated below the shoulder 28.

Aspirated air/liquid mixture, which enters the casing segment 21 from the inlet port 29 via the spiral duct 35, flows downwards subject to turbulence and then, under the vortex effect of the radial-flow blower 60 connected to the air outlet 37, flows from below into the sector-shaped chambers of the rotor 22 delimited by the blades 25. On this path, liquid residual components are separated out under centrifugal force on the outer wall of the cyclone separator and then drip directly into the pump impeller 23.

In the rotor 22, fine liquid droplets and foam components that have possibly been entrained are pushed against the inner wall of the rotor 22 by the centrifugal action and flow down the inner wall which widens in the downward direction. From there, the liquid drips into the pump impeller 23 and under centrifugal action is pushed outwards, where it is conveyed to the liquid-outlet port 24 by the pump blades 27.

The drive shaft 34 of the separating unit 20 extends through the air-exit opening in the intermediate flange 30 and through the air-outlet chamber of the casing segment 31 as far as the transmission 36.

At the upper end of the drive shaft 34 there is seated a large gearwheel 32 which is driven by a smaller gearwheel 33. The reduction ratio amounts to approximately 1:3.

The gearwheel 33 is seated on a shaft 42 which extends centrally through the casing segment 41 as far as the impeller 62. Within the casing segment 41 a rotor 44 of an electrically commutated electric motor (EC motor) 43, which is realised as an external-rotor motor, is seated on the shaft 42.

Ordinarily in an electric motor an internal rotor rotates, and the outer casing is stationary. In the external-rotor motor being used here, the converse is the case. The external motor casing provided with permanent magnets serves as rotor 44 and rotates, whereas the armature 45 (stator), which consists of several air-cored coils, is stationary in the interior. This results in a particularly compact type of construction and makes large torques possible. But, alternatively, use may also be made of an internal-rotor EC motor.

Conventional electric motors usually work with brushes, in order to change the direction of the current in the winding always at the correct time. This brush appliance causes mechanical and electrical losses, is susceptible to wear, and causes electromagnetic receiving disturbance. In the case of electrically commutated motors, on the other hand, the commutation is realised with control electronics (motor controller), which generates a circumferential magnetic field through the air-cored coils of the armature 45. The stated disadvantages of the brushes do not arise here. As a result, a brushless motor exhibits a better efficiency.

The cup-shaped rotor 44 is connected on the underside to the shaft 42, whereas on the upper side it is open.

From above, a bearing sleeve 53 projects downwards from the cover 51, in which bearing sleeve the shaft 42 is supported, and on the outside of which the armature 45 with its air-cored coils is seated.

The motor controller is accommodated on two printed circuit boards 46 inside the casing segment 41, of which the lower printed circuit board extends concentrically around the rotor 44, whereas the other is fitted above the armature 42 on the bearing sleeve 53. Alternatively, of course, the motor controller may also be accommodated in an external casing.

In order to cool the motor controller, in addition a fan, which is not shown here and which is preferentially also driven by the shaft 42, can be accommodated in the casing segment 41.

Via the motor controller the suction power of the suction machine can be regulated in relatively simple manner in accordance with the current requirement at the treatment sites (e.g. 1-4 treatment sites) by regulation of the speed. To this end, the partial vacuum in the suction line can be measured, and the speed can be regulated accordingly.

In addition, the motor controller is provided with a motor-current limitation (blocking safeguard).

The impeller 62 of the radial-flow blower 60 is seated on the upper end of the shaft 42. Said impeller encompasses a lower flat disc 72 and an upper frustoconical disc 72. The disc spacing consequently diminishes from the inside to the outside.

Between the two discs 71, 72 there are located vanes 73 exhibiting axially parallel generating lines, which extend from the centre on curved lines radially as far as the edge of the discs 71, 72. Alternatively, radially terminating vanes are also possible.

The upper disc 71 of the impeller 62 has an air inlet centrally which leads into the air conduit 65 of the spiral casing 61. For the purpose of better sealing in relation to the working chamber 67, on the air inlet a vertical port 74 is fitted which encloses a corresponding, downward extending collar 75 at the air conduit 65 with slight clearance.

If the impeller 62 is set in rapid rotation by the EC motor 43, air is aspirated through the central air inlet in the impeller 62 and is pushed outwards by the curved vanes 73 through the gap between the two discs 71, 72, then rotates in the working chamber 67 and flows through the air-outlet opening 68 and the spiral duct 69 to the air outlet 64, and from there into the open via a pipeline routed across the roof.

The fan propeller 62, the shaft 42 and the EC motor 43 are designed for very high speeds of rotation within the range 12,000 rpm to 15,000 rpm. By virtue of the transmission ratio (gearwheels 32, 33), on the other hand, the drive shaft 34—and with it the rotor 20 and the pump impeller 23 of the separating unit 20—runs only at relatively lower speeds within the range from 2800 rpm to 4000 rpm, as preferred for the separation.

By virtue of the lower speeds, the gearwheel 32 can be constructed from plastic, such as, for example, PTFE or PE; the gearwheel 33, on the other hand, is produced from metal, for example from brass or high-grade steel. With this combination of materials, a lubrication of the transmission 36 can be dispensed with.

As an alternative to the gearwheel transmission 36, a planetary gear train, a V-belt transmission or a toothed-belt transmission or a friction-gear transmission can also be employed for the purpose of coupling the separating unit 20 and the radial-flow blower 60.

The parts of the radial-flow blower 60 rotating at high speed have to be well balanced. The ball bearings, not shown here, by which the shaft 42 is supported have to be kept small in diameter. Additionally, a cooling of the bearings may be required, as well as the use of high-temperature grease and a sealing of the ball bearings.

The axial operating gaps of the radial-flow blower 60, on the other hand, may be relatively large within the range of about 1-3 mm. This simplifies the assembly, since an accurate spacing is not required, and makes the radial-flow blower 60 insensitive to aspirated foam and dust. Casing parts such as the spiral casing 61 or the casing segment 41 can be manufactured from plastic, resulting in lower production costs.

The impeller 62 itself can be constructed to be relatively lightweight, preferably from aluminium. This enables a rapid start-up of the suction machine. Alternatively, only the lower disc 72 of the impeller may be manufactured from aluminium, and the upper disc 71 with the vanes 73 from plastic, in which case the two discs 71, 72 are thermally riveted together.

By reason of the better efficiency of the radial-flow blower 60 and the EC motor 43, the motor output for a suction machine that is designed for the maintenance of up to four treatment sites in the exemplary embodiment amounts to only 0.95 kW.

In addition, in a further development, not shown here, a separation of solids components—such as drilled amalgam, for example—may be undertaken.

To this end, the pump impeller 23 is replaced by a centrifuge basket, the bottom of which exhibits a sludge-drainage aperture, through which the solids component can sink down into a collecting tank when the centrifuge is discharged.

1. A suction machine with a separating unit including a rotor being capable of separating liquid and/or solid constituents out of an aspirated air/liquid and/or solids mixture and with a suction fan that is connected to an air outlet of the separating unit and which exhibits a casing and also an impeller,
wherein
the impeller is driven by an electrically commutated electric motor, and the latter also drives the rotor of the separating unit via a transmission.

2. The suction machine of claim 1, wherein the separating unit and the radial-flow blower are mechanically coupled with one another by the transmission in such a manner that the separating unit runs more slowly than the radial-flow blower.

3. The suction machine of claim 1, wherein the transmission is a gearwheel transmission or a friction-gear transmission.

4. The suction machine of claim 3, wherein the transmission is an obliquely toothed gearwheel transmission.

5. The suction machine of claim 3, wherein the gearwheel transmission exhibits a gearwheel made of plastic and a gearwheel engaging therein made of metal.

6. The suction machine of claim 1, wherein the motor together with a motor controller is accommodated in a casing segment, and a fan is provided for cooling the motor controller.

7. The suction machine of claim 6, wherein the fan for the motor controller is driven by the drive shaft of the radial-flow blower.

8. The suction machine of claim 1, wherein the air outlet of the separating unit is connected to a suction port of the suction fan via an external pipeline.

9. The suction machine of claim 1, wherein the separating unit includes a cyclone-separator stage and a centrifuge stage including the rotor, which are arranged coaxially.

10. The suction machine of claim 1, wherein the electric motor is an external-rotor motor.

11. The suction machine of claim 2, wherein the transmission is a gearwheel transmission or a friction-gear transmission.

12. The suction machine of claim 4, wherein the gearwheel transmission exhibits a gearwheel made of plastic and a gearwheel engaging therein made of metal.

13. The suction machine of claim 12, wherein the motor together with a motor controller is accommodated in a casing segment, and a fan is provided for cooling the motor controller.

14. The suction machine of claim 2, wherein the motor together with a motor controller is accommodated in a casing segment, and a fan is provided for cooling the motor controller.

15. The suction machine of claim 3, wherein the motor together with a motor controller is accommodated in a casing segment, and a fan is provided for cooling the motor controller.

16. The suction machine of claim 4, wherein the motor together with a motor controller is accommodated in a casing segment, and a fan is provided for cooling the motor controller.

17. The suction machine of claim 5, wherein the motor together with a motor controller is accommodated in a casing segment, and a fan is provided for cooling the motor controller.

18. The suction machine of claim 2, wherein the air outlet of the separating unit is connected to a suction port of the suction fan via an external pipeline.

19. The suction machine of claim 3, wherein the air outlet of the separating unit is connected to a suction port of the suction fan via an external pipeline.

20. The suction machine of claim 4, wherein the air outlet of the separating unit is connected to a suction port of the suction fan via an external pipeline.
